(19) United States
(12) Patent Application Publication
(10) Pub. No.: US 2014/0132635 A1
(43) Pub. Date: May 15, 2014

(54) SYSTEMS AND METHODS FOR ROOF AREA ESTIMATION

(71) Applicants: Ali Murdoch, Northport, NY (US); Keith T. Tobias, Mastic Beach, NY (US)

(72) Inventors: Ali Murdoch, Northport, NY (US); Keith T. Tobias, Mastic Beach, NY (US)

(21) Appl. No.: 14/075,129

(22) Filed: Nov. 8, 2013

Related U.S. Application Data
(60) Provisional application No. 61/724,741, filed on Nov. 9, 2012.

(51) Int. Cl. G06T 11/60; G06T 3/00; G06T 7/00; G06T 3/40; G01B 21/28; G09G 5/14; G06T 3/60

(52) U.S. Cl. CPC G06T 11/60; G09G 5/14; G06T 3/0068; G06T 3/60; G06T 3/40; G01B 21/28; G06T 7/0051
USPC 345/641

(57) ABSTRACT

Systems and methods for computer-implemented determination of an estimated roof surface area are disclosed. In an embodiment of the invention, an aerial roof image is retrieved and displayed for a user. One or more of a plurality of stored roof templates are displayed with the aerial roof image. One of the roof templates may be selected so as to select a corresponding clear frame model to be overlayed on the aerial roof image. Nodes provided at vertices of the clear frame model may be aligned with corresponding vertices on the aerial roof image to change the dimensions of the clear frame roof model by dragging and dropping the nodes. One or more pitch values may be selected for association with the clear frame model. An estimated surface area of the roof is calculated and displayed based on the area of the resulting clear frame model and the one or more pitch values.

### CROSS REFERENCE TO RELATED APPLICATIONS

This application relates to, and claims the benefit of the earlier filing date and priority of U.S. Provisional Patent Application No. 61/724,741, filed on Nov. 9, 2012, and entitled “Systems And Methods For Roof Area Estimation.”

### FIELD OF THE INVENTION

The present invention relates to computer-based systems and methods for estimating the surface area of a roof using an aerial image, such as, but not limited to, an aerial image taken from an earth orbiting satellite.

### BACKGROUND OF THE INVENTION

Prior to having a building roof replaced or repaired, it is common for the building owner, manager or insurer to request an estimate of the cost of the replacement or repair project. An estimate of the cost of replacing or repairing a roof may be dependent on a number factors. One such prominent factor is the surface area or size, of the roof, which dictates the amount of roofing materials and time required for the replacement or repair project.

There are several known computer-based methods and systems for providing detailed and precise estimates of the surface area of a roof. For example, U.S. Pat. No. 8,145,578 to Pershing et al. discloses an aerial roof estimation system and method which permits an aerial image of a roof to be used to estimate the surface area of the roof. The Pershing et al. system, however, requires detailed analysis of roof geometries and pitch in order to produce an estimate of the roof surface area. Such a detailed analysis, while potentially very accurate, cannot be prepared in real-time (e.g., within seconds or minutes), because it requires significant and time consuming interaction between the roof estimation system software and a user. Specifically, the user of the Pershing et al. system is required to extract geometric information concerning a roof from the aerial image by hand tracing roof dimensions taken from the aerial image.

U.S. Patent Publication No. 2008/0021683 to Rahmes et al. discloses a geospatial modeling system providing building roof type identification features and methods. The Rahmes et al. system utilizes a geospatial model database to identify a building roof type automatically using a processor. The processor may apply multi-directional gradient calculations to building roof data points in order to determine a building roof type as being from among a plurality of possible building roof types. In the Rahmes et al. system, however, the user does not control the selection of building roof types to overlay on an aerial image, but must rely upon the processor to select the correct roof type. Such a system is complicated and can permit errors in roof type selection.

Both the Pershing et al. and Rahmes et al. systems, described above, lack the ability to permit a user to quickly apply a roof model to an aerial roof image in real-time while maintaining user control over the matching of the roof model with the aerial roof image. Accordingly, there is a need for roof modeling system which permits a user to quickly and manually select roof templates from a roof template menu, overlay the roof templates on an aerial image roof image, and adjust the dimensions of the overlayed roof template to match the dimensions of the aerial roof image to estimate the surface area of the roof. Further, there is a need for such a system which can provide such an estimate utilizing assumed roof pitch information rather than actual or computer determined roof pitch information.

### SUMMARY OF THE INVENTION

Responsive to the foregoing challenges, Applicants have developed an innovative computer-implemented method of determining an estimated surface area of a roof, comprising the steps of: receiving an aerial roof image using a computer associated with a computer display; displaying the aerial roof image on the computer display; accessing a computer memory having a plurality of stored roof templates and associated clear frame models, wherein each clear frame model includes a node at each clear frame model vertex, and wherein said stored roof templates include two or more of a flat roof template, hipped roof template, gable roof template, gambrel roof template, mansard roof template, cross-hipped roof template, intersecting roof template, butterfly roof template, a shed roof template, an add-on gable roof template, an add-on hip roof template, and a pyramid roof template; displaying one of the plurality of stored roof templates on the computer display at the same time that the aerial roof image is displayed on the computer display; selecting the one of the plurality of stored roof templates so as to select a corresponding clear frame model; overlaying the corresponding clear frame model on the aerial roof image responsive to selection of the one of the plurality of roof templates by a first user input to the computer; aligning each node of the corresponding clear frame model with a corresponding vertex on the aerial roof image responsive to one or more additional user inputs to the computer; selecting one or more pitch values for association with the corresponding clear frame model; determining an estimated surface area of the roof based on the area of the corresponding clear frame model responsive to the selection of the one or more pitch values and the alignment of each node of the corresponding clear frame model with a corresponding vertex on the aerial roof image; and displaying the estimated surface area of the roof on the computer display.

Applicants have further developed an innovative computer-implemented system for determining an estimated surface area of a roof, comprising: means for displaying the aerial roof image on the computer display; a computer memory having a plurality of stored roof templates and associated clear frame models, wherein each clear frame model includes a node at each clear frame model vertex, and wherein said stored roof templates include two or more of a flat roof template, hipped roof template, gable roof template, gambrel roof template, mansard roof template, cross-hipped roof template, intersecting roof template, butterfly roof template, a shed roof template, an add-on gable roof template, an add-on hip roof template, and a pyramid roof template; means for displaying one of the plurality of stored roof templates on the computer display at the same time that the aerial roof image is displayed on the computer display; means for selecting the one of the plurality of stored roof templates so as to select a corresponding clear frame model; means for overlaying the corresponding clear frame model on the aerial roof image responsive to selection of the one of the plurality of roof templates by a first user input to the computer; means for aligning each node of the corresponding clear frame model with a corresponding vertex on the aerial roof image responsive to one or more additional user inputs to the computer; means for selecting one or more pitch values for association with the corresponding clear frame model; means for determining an estimated surface area of the roof based on the surface area of the corresponding clear frame model responsive to the selection of the one or more pitch values and the alignment of each node of the corresponding clear frame model with a corresponding vertex on the aerial roof image; and means for displaying the estimated surface area of the roof on the computer display.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements.

FIG. 1 is a schematic diagram of a system embodiment of the present invention.

FIG. 2 is a computer display generated by a system and method embodiment of the present invention showing an aerial roof image.

FIG. 3 is a computer display generated by a system and method embodiment of the present invention showing an aerial roof image after rotation.

FIG. 4 is a computer display generated by a system and method embodiment of the present invention showing an aerial roof image after alignment.

FIG. 5 is a computer display generated by a system and method embodiment of the present invention showing an aerial roof image and a plurality of roof templates in a roof template menu.

FIGS. 6 is a computer display generated by a system and method embodiment of the present invention showing an aerial roof image with an overlayed clear frame model of a roof template during a first phase of manipulation of the clear frame model.

FIG. 7 is a computer display generated by a system and method embodiment of the present invention showing an aerial roof image with an overlayed clear frame model of a roof template during a second phase of manipulation of the clear frame model.

FIG. 8 is a computer display generated by a system and method embodiment of the present invention showing an aerial roof image with an overlayed clear frame model of a roof template during a third phase of manipulation of the clear frame model.

FIG. 9 is a computer display generated by a system and method embodiment of the present invention showing an aerial roof image with an overlayed clear frame model of a roof template during a calculation of surface area phase.

FIG. 10 is a flow chart illustrating the steps of a preferred method embodiment of the present invention.

FIG. 11 is a clear frame model of a first gable roof clear frame model shown in accordance with an embodiment of the present invention.

FIG. 12 is a clear frame model of a modified second gable roof clear frame model section shown in accordance with an embodiment of the present invention.

FIG. 13 is a clear frame model of the overlap of the dear frame models shown in FIGS. 11 and 12.

### DETAILED DESCRIPTION OF EMBODIMENTS OF THE INVENTION

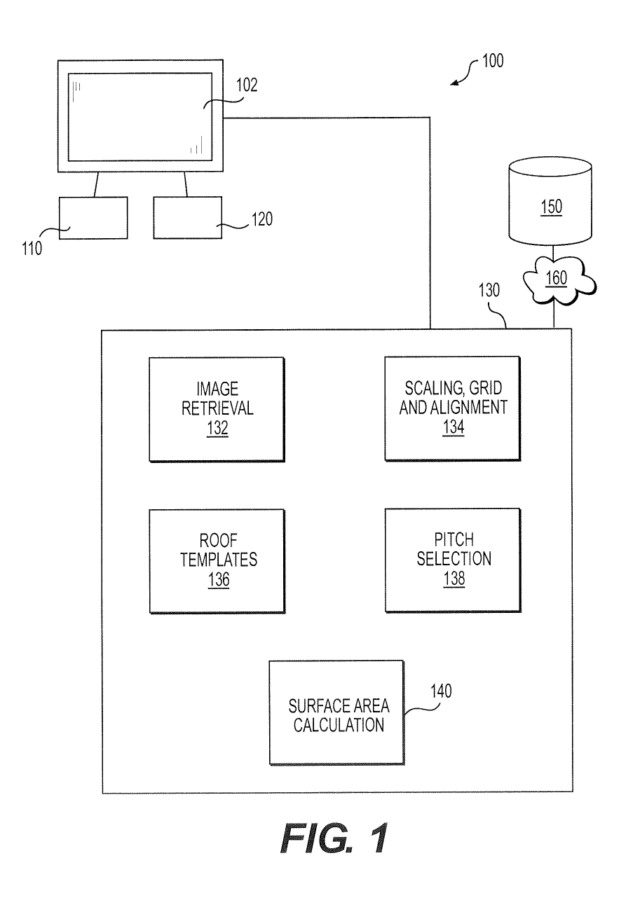

With reference to FIG. 1, in one or more embodiments of the present invention, system 100 includes a computer display 102, a keyboard input device 110, a mouse/trackball input device 120 and computer processor and memory hardware 130. In alternative embodiments, the keyboard input device 110 and/or the mouse/trackball input device may be integrated into a touch screen computer display 102. The computer display 102, keyboard input device 110 and the mouse/trackball input device 120 permits a user to interact with the system 100. In some embodiments of the invention, the computer processor and memory hardware required to implement the invention may be integrated with and/or local to the display 102, while in other embodiments of the invention such computer processor and memory hardware may be provided through a remote web server which serves interactive web pages to input information from a user and to provide responsive images and surface area determinations

The computer display 102 may be controlled by the computer processor and memory hardware 130 to provide fields for input of information by a user, including but not limited to customer/homeowner identification, user identification, site address, insurance information, and the like.

The computer processor and memory hardware 130 may be of any type which is capable of storing computer code and data required to implement the various embodiments of the invention. Collectively, the computer processor and memory hardware 130 may be utilized to implement image retrieval subsystem 132, scaling, grid application and image alignment subsystem 134, roof template subsystem 136, roof pitch selection subsystem 138, and surface area calculation subsystem 140.

System 100 receives user input or utilizes global positioning satellite (gps) information to determine the location of a site/building which has a roof for which the surface area is to be estimated. The site location, which may preferably be in the form of a street address, may be provided to the image retrieval subsystem 132.

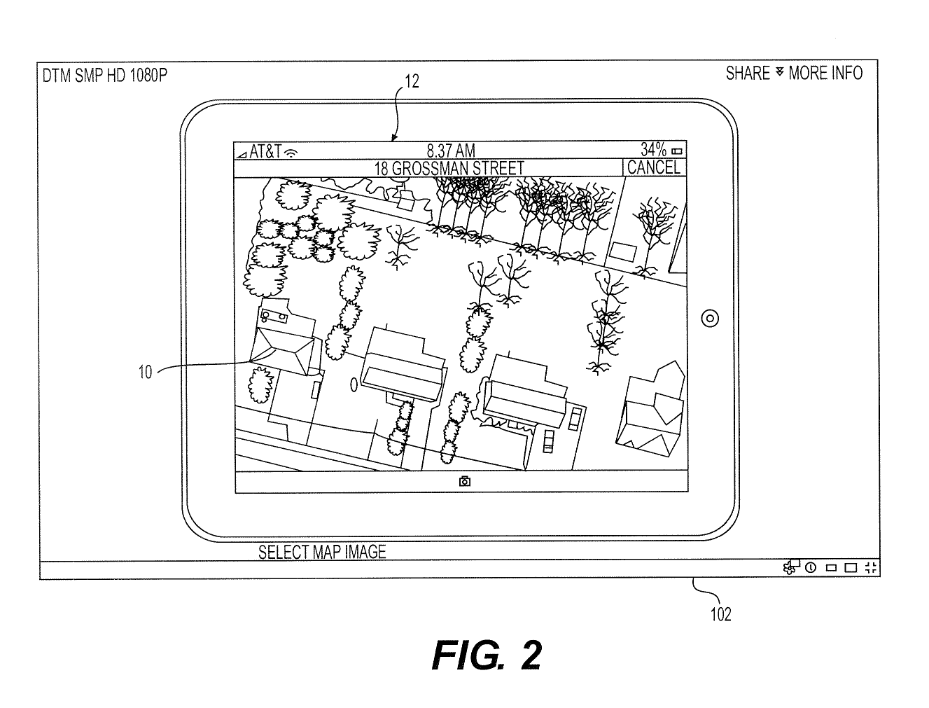

With reference to FIGS. 1 and 2, the image retrieval subsystem 132 may use the site location to retrieve an image 12 of the site from a local or remote image memory or database 150. A remote image database, such as the Google Earth™ database, may be accessed via an Internet connection 160 by the image retrieval subsystem 132 to obtain the required image. The image 12 may be in the form of an aerial photograph taken by satellite or other aerial platform. The image 12, taken from overhead, may show the roof 10 of a building, such as a home, on the computer display 102.

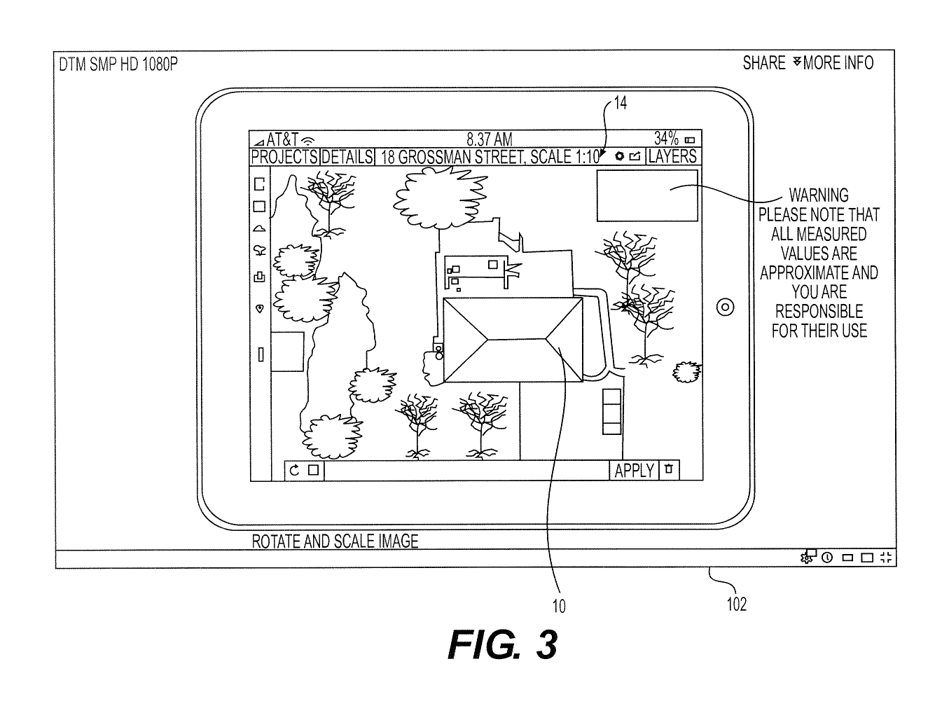

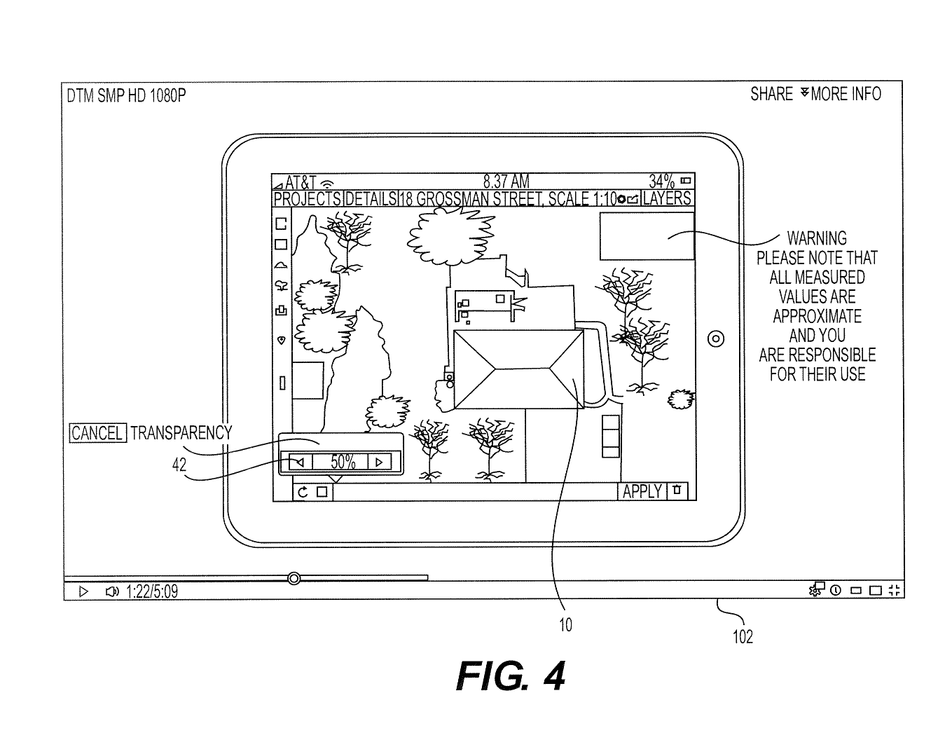

With reference to FIGS. 1-4, the image of the roof 10 may be manipulated by user input to the scaling, grid and alignment subsystem 134 using the display 102, keyboard input device 110, and/or the mouse/trackball input device 120. As is evident from comparison of FIGS. 2 and 3, the scaling, grid and alignment subsystem 134 permits a user to enlarge the image of the roof 10, place the roof image in the center of the computer display 102, and rotate the roof image so that the major roof lines are substantially parallel to the computer display 102 boundaries. A toolbar (not shown) for rotating, moving and enlarging the roof image may be provided by the scaling, grid and alignment subsystem 134. The scaling, grid and alignment subsystem 134 may automatically provide an indication of the scale 14 of the roof image 10. With reference to FIG. 4, the scaling, grid and alignment subsystem 134 may also provide a toolbar 42 which may receive user input to adjust the transparency of a grid pattern overlayed on the roof image 10.

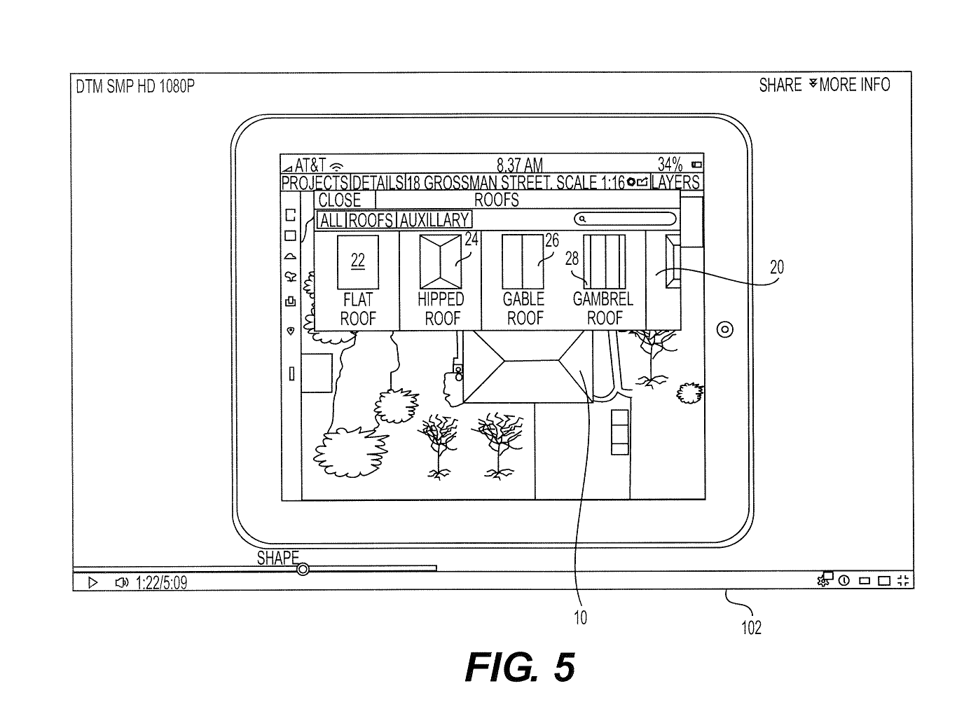

With reference to FIG. 5, a roof template toolbar 20 on the computer display 102 may be accessed in response to a user input. Roof templates, including but not limited to a flat roof template 22, hipped roof template 24, gable roof template 26, gambrel roof template 28, mansard roof template 30, cross-hipped roof template, intersecting roof template, butterfly roof template, shed roof template, add-on gable roof template, add-on hip roof template, and a pyramid roof template, may be provided by the roof templates subsystem 136 (FIG. 1) for display on the computer display 102. Each of these roof templates is defined by connected outer roof perimeter edges (i.e., represented by lines) which each meet at a roof vertex (i.e., point of intersection). The roof templates may further include one or more ridge lines defined by the intersection of two or more adjacent planar surfaces provided on the roof. For example, with reference to FIG. 5, the roof image 10 corresponds to the hipped roof template 24 in that each have a rectangular outer perimeter and five interior ridge lines which collectively define the overall roof into two opposing triangular sections and two opposing trapezoidal sections. Almost all roofs can be modeled by the roof templates listed above, either individually, or by combining two or more of the roof templates.

With continued reference to FIG. 5, a user may review the pictorial list of roof templates 20 until a roof template that appears to match all or a portion of the roof 10 for which a surface area estimate is required is identified. At least one of the roof templates 22, 24, 26 and 28 are displayed at a time, however, in a preferred embodiment, a plurality of roof templates are displayed at the same time, as shown in FIG. 5. The pictorial list of roof templates may be scrolled through using a mouse/trackball input device in a preferred embodiment.

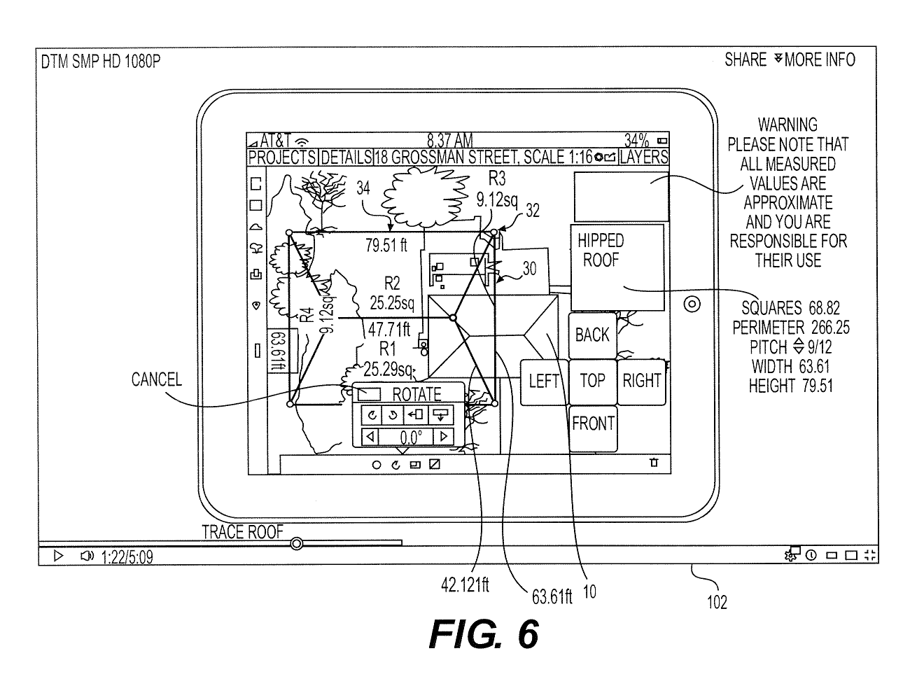

Once the appropriate roof template is identified, the user may then use the keyboard input device 110, and/or mouse/trackball input device 120 to select a roof template shape to be overlayed on the roof image. In the example shown in FIGS. 5-9, the user selects the hipped roof template 24. With reference to FIG. 6, once the hipped roof template 24 is selected, the roof templates subsystem 136 renders a clear frame model 30 having the perimeter and ridge lines of the selected roof template, which in this case is a hipped roof, on the display 102, as well as a toolbar 40 for manipulation of the clear frame model. The toolbar 40 may include icons that permit the user to rotate the clear frame model, change its dimensions, and/or select and deselect an individual section 34 of the clear frame model. Selection of an individual section 34 may cause the section to (a) be rendered in a shaded manner, as shown in FIG. 6 for the top inverted trapezoidal shaped roof section, and (b) to be included in the final surface area calculation. Non-selected roof sections (i.e., the non-shaded roof sections in FIG. 6) may be excluded from the final roof surface area calculation. In this manner, an estimate of the surface area of only a portion of a roof may be provided, to account for situations such as when only a partial roof repair or replacement is required.

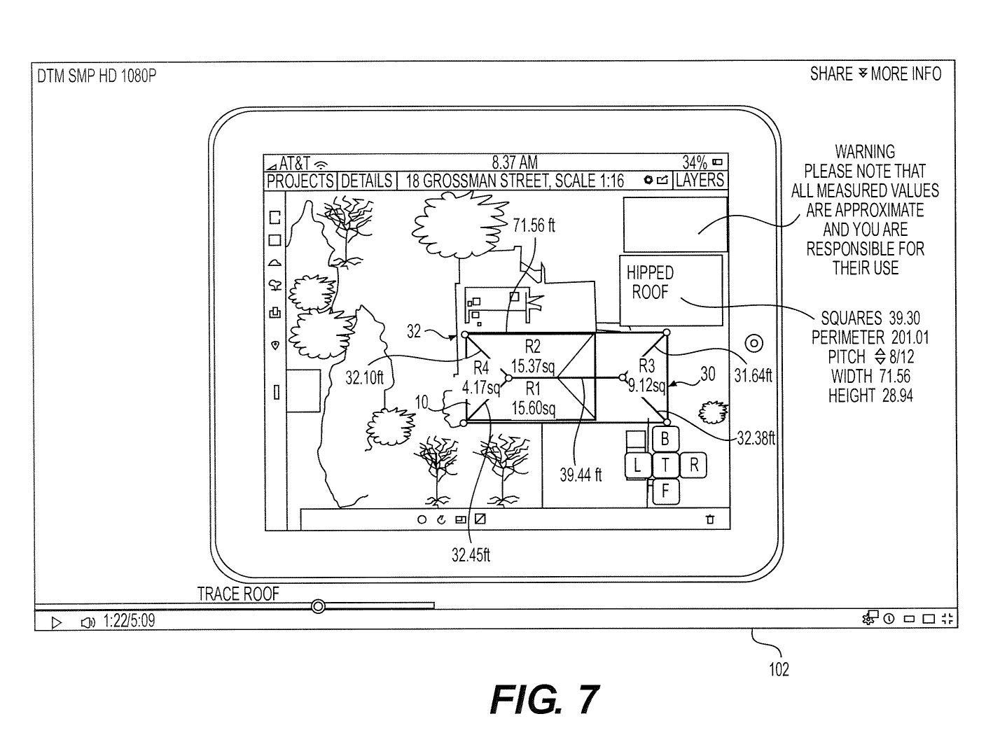

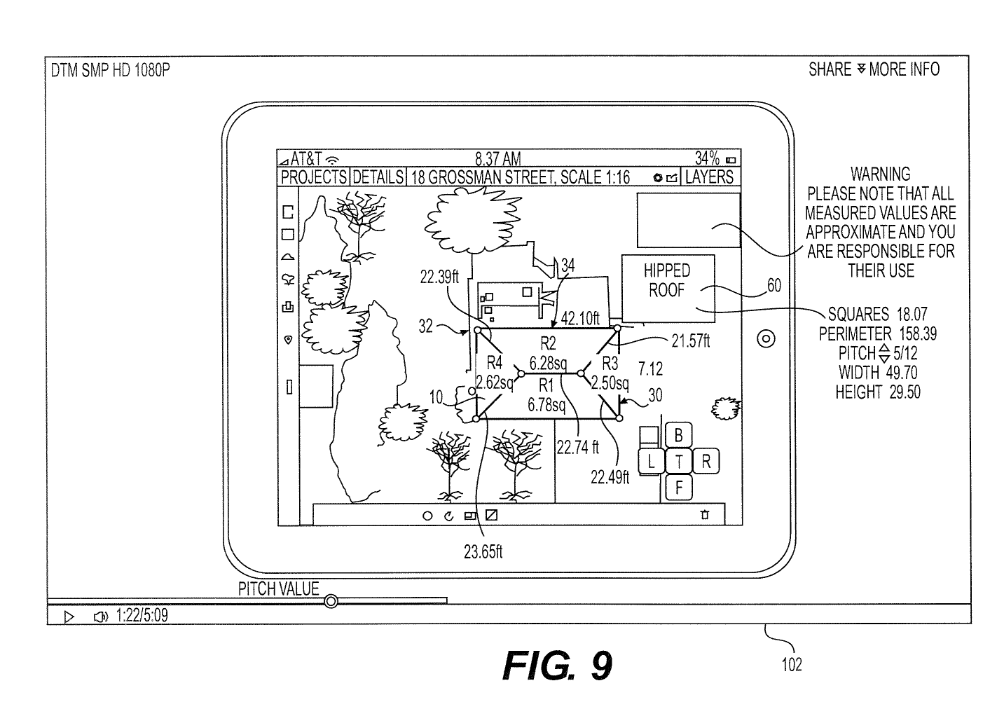

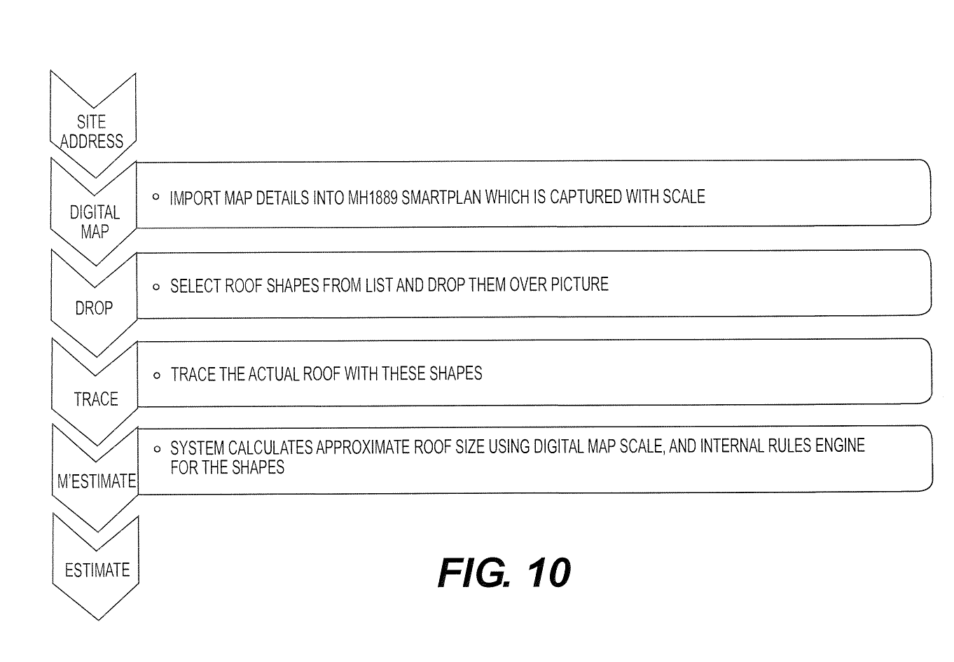

With continued reference to FIG. 6, the clear frame model 30 is rendered so that it does not obscure the underlying roof image 10, but permits the user to “see through” so that the clear frame model can be aligned by the user with the roof image. The clear frame model 30 includes nodes 32 at each roof perimeter and ridge line vertex (i.e., the intersections of the roof perimeter lines with each other and the roof ridge lines). With reference to FIGS. 6-7, which show the progression of the interaction of a user with the system 100, the roof templates subsystem 136 permits the user to “drag and drop” each of the nodes 32 of the clear frame model 30 so that the user may quickly and easily align each of the clear frame model nodes with corresponding vertices on the roof image 10. This process is shown complete in FIG. 9, in which all of the roof sections are included in the estimate since they are all shown as being shaded.

In the event that the roof image comprises more than one of the roof templates (which is not the case in FIGS. 2-9), the user may cause the roof templates subsystem 136 to again render the pictorial roof templates list 20 on the display 102 for selection of a second roof template to be overlayed on the roof image. Alternatively, the user may select more than one roof template at a time to manipulate on the display 102 under control of the tool bar 40. The user may “toggle” between roof templates for manipulation by interaction with the roof templates subsystem, for example by “clicking” on a roof template to indicate that is the template to be manipulated.

The user may also add and manage representations of additional roof elements on the display using an additional roof elements toolbar. The additional roof elements toolbar may be used to access representations of the additional roof elements stored in a computer memory and cause such representations to be displayed and overlayed onto the roof image. The additional roof elements may include skylight shapes, turtle vent shapes, ridge vent shapes, chimney flash shapes and slant back vent shapes. The overlaying of additional roof elements on the roof image may be taken into account when the computer calculates the roof surface area.

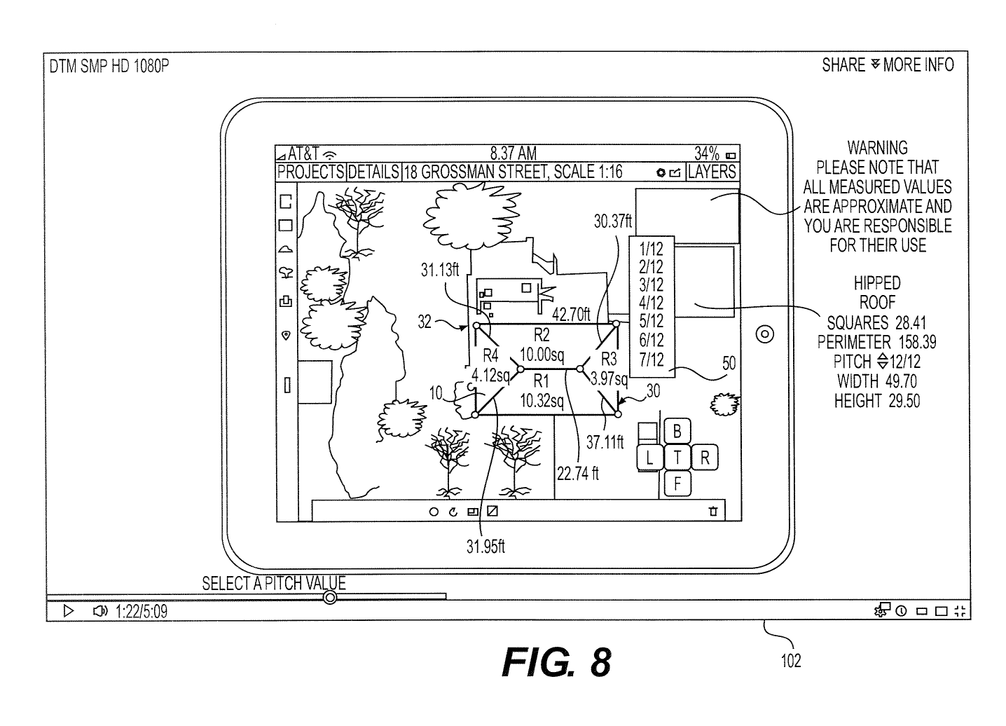

With reference to FIG. 8, once the user has aligned each of the nodes 32 with corresponding vertices on the roof image 10, the user may activate the pitch selection subsystem 138, which causes a pitch selection menu 50 to be rendered on the display 102. The user may then select a pitch for each of the roof sections in the clear frame model 30, or for the entire clear frame model.

With reference to FIG. 9, after completion of the pitch selection process, the surface area of each of the selected roof sections 34 is calculated based on the selected pitch information, scale information, and clear frame model 30 dimensions. The determined roof surface area estimate may then be displayed on the computer display in field 60. The surface area estimate may include an estimate of the number of roofing squares of shingles required for the roof repair or replacement.

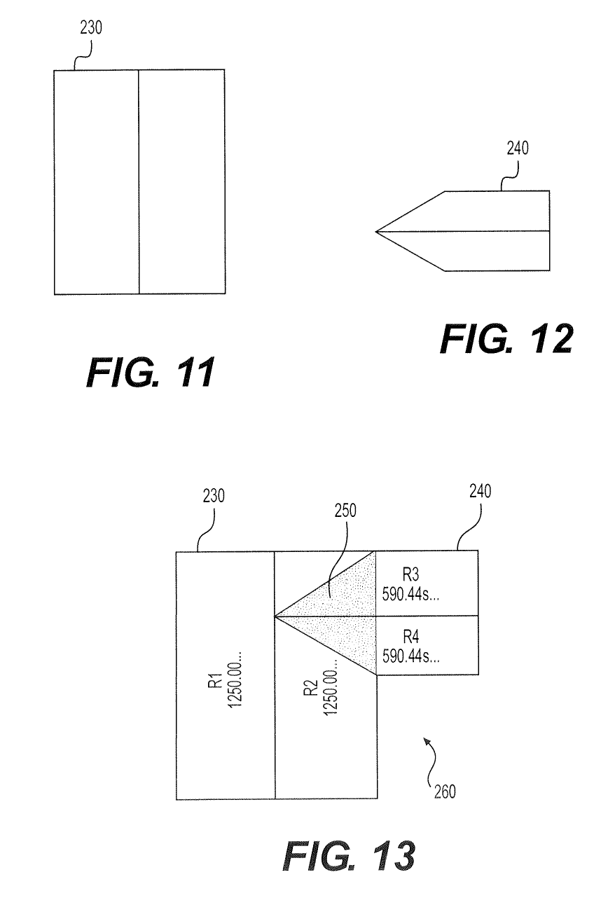

With reference to FIGS. 11-13, an embodiment of the invention is explained in which multiple clear frame models are used to determine the estimated surface area of a roof. With regard to FIGS. 11-13, the surface area calculation of the overall roof will take into account only the top surface area of two or more overlapping clear frame models. For example, if the gable roof clear frame model 230 shown in FIG. 11 is overlayed with the modified gable roof clear frame model 240 shown in FIG. 12, to produce the composite clear frame model roof 260 shown in FIG. 13, the shaded overlap area 250 will be counted towards the overall surface area calculation only for the top clear frame model 240. Accordingly, the lower overlap area 250 attributable to the gable roof clear frame model 230 will be subtracted from the overall surface area calculation. As a result, the overlap area 250 will not be counted twice for the surface area calculation. In fact, only the surface area of the top modified gable roof clear frame model 240 is counted towards the overall surface area calculation.

It will be apparent to those skilled in the art that variations and modifications of the present invention can be made without departing from the scope or spirit of the invention. It is intended that the present invention cover all such modifications and variations of the invention, provided they come within the scope of the appended claims and their equivalents.

What is claimed is:

1. A computer-implemented method of determining an estimated surface area of a roof, comprising the steps of:
receiving an aerial roof image using a computer associated with a computer display;
displaying the aerial roof image on the computer display under the direction of the computer;
accessing a computer memory under the direction of the computer, said computer memory having a plurality of stored roof templates and associated clear frame models, wherein each clear frame model includes a node at each clear frame model vertex, and wherein said stored roof templates include two or more of a flat roof template, hipped roof template, gable roof template, gambrel roof template, mansard roof template, cross-hipped roof template, intersecting roof template, butterfly roof template, a shed roof template, an add-on gable roof template, an add-on hip roof template, and a pyramid roof template;
displaying, under the direction of the computer, one of the plurality of stored roof templates on the computer display at the same time that the aerial roof image is displayed on the computer display;
selecting, as a result of user input to the computer, the one of the plurality of stored roof templates so as to select a corresponding clear frame model;
overlaying the corresponding clear frame model on the aerial roof image responsive to selection of the one of the plurality of roof templates as a result of user input to the computer;
aligning each node of the corresponding clear frame model with a corresponding vertex on the aerial roof image responsive to one or more additional user inputs to the computer;
displaying, under the direction of the computer, one or more pitch values for association with the corresponding clear frame model;
selecting, as a result of user input to the computer, one or more pitch values for association with the corresponding clear frame model;
determining an estimated surface area of the roof based on the area of the corresponding clear frame model responsive to the selection of the one or more pitch values and the alignment of each node of the corresponding clear frame model with a corresponding vertex on the aerial roof image; and
displaying an indication of the estimated surface area of the roof on the computer display.

2. The computer-implemented method of claim 1 further comprising the step of displaying a grid over the aerial roof image.

3. The computer-implemented method of claim 2 further comprising the step of displaying an image rotation toolbar on the image display, said image rotation toolbar adapted to permit rotation of the aerial roof image for alignment with the displayed grid.

4. The computer-implemented method of claim 3 further comprising the step of displaying a clear frame model manipulation toolbar on the image display, said clear frame model manipulation toolbar adapted to permit rotation and dimension modification of the corresponding clear frame model for alignment with the aerial roof image.

5. The computer-implemented method of claim 1, wherein the corresponding clear frame model includes a plurality of model sections which collectively make up the clear frame model, and further comprising the steps of:
selecting one of the plurality of model sections for inclusion in the step of determining an estimated surface area of the roof; and
excluding non-selected ones of the plurality of model sections from the step of determining an estimated surface area of the roof.

6. The computer-implemented method of claim 1, wherein the plurality of stored roof templates are displayed in a menu bar.

7. The computer-implemented method of claim 6, wherein the plurality of stored roof templates include roof shapes having a complete perimeter and two or more ridge lines.

8. The computer-implemented method of claim 1, further comprising displaying two or more of the plurality of stored roof templates on the computer display at the same time that the aerial roof image is displayed on the computer display.

9. The computer-implemented method of claim 1, further comprising the steps of:
displaying, under the direction of the computer, stored additional roof elements;
overlaying one or more of the stored additional roof elements on the roof image as a result of user input to the computer; and
determining the estimated surface area of the roof based in part on the overlaying of one or more of the stored additional roof elements on the roof image.

10. A computer-implemented system for determining an estimated surface area of a roof, comprising:
means for displaying the aerial roof image on the computer display;
a computer memory having a plurality of stored roof templates and associated clear frame models, wherein each clear frame model includes a node at each clear frame model vertex, and wherein said stored roof templates include two or more of a flat roof template, hipped roof template, gable roof template, gambrel roof template, mansard roof template, cross-hipped roof template, intersecting roof template, butterfly roof template, a shed roof template, an add-on gable roof template, an add-on hip roof template, and a pyramid roof template;
means for displaying one of the plurality of stored roof templates on the computer display at the same time that the aerial roof image is displayed on the computer display;
means for selecting the one of the plurality of stored roof templates so as to select a corresponding clear frame model;
means for overlaying the corresponding clear frame model on the aerial roof image responsive to selection of the one of the plurality of roof templates by a user input to the computer;
means for aligning each node of the corresponding clear frame model with a corresponding vertex on the aerial roof image responsive to one or more additional user inputs to the computer;
means for selecting one or more pitch values for association with the corresponding clear frame model;
means for determining an estimated surface area of the roof based on the surface area of the corresponding clear frame model responsive to the selection of the one or more pitch values and the alignment of each node of the corresponding clear frame model with a corresponding vertex on the aerial roof image; and
means for displaying an indication of the estimated surface area of the roof on the computer display.

11. The computer-implemented system of claim 10, wherein the corresponding clear frame model includes a plurality of model sections which collectively make up the clear frame model, and further comprising:
means for selecting one of the plurality of model sections for inclusion in the step of determining an estimated surface area of the roof and excluding non-selected ones of the plurality of model sections from the step of determining an estimated surface area of the roof.

12. The computer-implemented system of claim 10 further comprising means for displaying a grid over the aerial roof image.

13. The computer-implemented system of claim 12 further comprising an image rotation toolbar on the image display, said image rotation toolbar adapted to permit rotation of the aerial roof image for alignment with the displayed grid.

14. The computer-implemented system of claim 13 further comprising a clear frame model manipulation toolbar on the image display, said clear frame model manipulation toolbar adapted to permit rotation and dimension modification of the corresponding clear frame model for alignment with the aerial roof image.

15. The computer-implemented system of claim 10, wherein the plurality of stored roof templates are displayed in a menu bar.

16. The computer-implemented system of claim 15, wherein the plurality of stored roof templates include roof shapes having a complete perimeter and two or more ridge lines
